(19) United States
(12) Patent Application Publication
(10) Pub. No.: US 2010/0274588 A1
(43) Pub. Date: Oct. 28, 2010

(54) SYSTEM AND METHOD TO MANAGE A WORKFLOW IN DELIVERING HEALTHCARE

(75) Inventor: Suresh K. Choubey, Delafield, WI (US)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 12/431,401

(22) Filed: Apr. 28, 2009

(51) Int. Cl. G06Q 50/00; G06Q 30/00; G06N 5/02; G01C 21/00; G06Q 10/00

(52) U.S. Cl. 705/3; 705/34; 705/2; 706/20; 701/300

(57) ABSTRACT

A system and method to manage progression of a patient through a workflow of events occurring in the delivery of healthcare to the patient is provided. The system can include a tracking system operable to acquire a location data of the patient relative to the at least one resource with progression through the workflow; and at least one processor in communication with a memory that stores computer-readable program instructions for execution by the processor to perform the steps of: detecting an association of the patient with the at least one resource dependent on the location data acquired from the tracking system; generating a classification of the patient as receiving emergency care versus receiving urgent care dependent on the association; and generating an output indicative of the classification for communication to a billing system to generate the invoice for delivery of healthcare to the patient.

### RELATED APPLICATIONS

Not Applicable.

### BACKGROUND

The subject herein generally relates to a system and method to manage progression of a patient through a workflow, and in particular, the distinction between urgent care workflow and emergency workflow.

Hospitals and other medical facilities (e.g., imaging centers, cardiology treatment centers, emergency rooms, surgical suites, etc.) include various workflows to deliver diagnosis or treatment to outpatients or admitted patients. These workflows are comprised of events that employ various resources such as imaging rooms, physicians, nurses, radiologists, cardiologists, clinicians, technicians, transcriptionists, and biomedical and medical equipment. These workflows are often unstructured and non-linear in nature due to complex conditions that dynamically evolve at any point in time of the workflow.

Known systems and methods to manage patients through these workflows delivered at healthcare facilities are generally static and non-adaptive. These known systems generally rely on past data and linear design assumptions to manage workflows (e.g., diagnostic imaging, cardiac treatment, etc.). As a result, these known systems and methods are generally inflexible or unresponsive to non-linear changes or events that increase the likelihood of chaos due to complex conditions that evolve in real time beyond the original linear design. Examples of parameters to measure a quality of service or efficiency of workflows include, but are not limited to, patient wait times, procedure turn-around times, resource utilization objectives, categorization of treatment type, insurance reimbursement, etc. For example, increasing procedure turn-around times can increase underutilization of resources (e.g., an imaging room sitting idle).

### BRIEF SUMMARY

The above-mentioned problems and needs are addressed by the subject matter described herein in the following description.

According to one embodiment, a system to manage progression of a patient through a workflow of events occurring in as room or defined space is provided. The workflow of events can be associated with at least one resource in the delivery of healthcare to the patient. The system can be in communication with a billing system to invoice the delivery of healthcare to the patient. The system can include a tracking system operable to acquire a location data of the patient relative to the at least one resource with progression through the workflow; and a controller in communication therewith. The controller can include at least one processor in communication with a memory of computer readable program instructions operable to instruct the processor to perform the steps of: detecting an association of the patient with the at least one resource dependent on the location data acquired from the tracking system; generating a classification of the patient as receiving emergency care versus receiving urgent care dependent on the association; and generating an output indicative of the classification for communication to a billing system to generate the invoice for delivery of healthcare to the patient.

According to another embodiment, a method to manage progression of a patient through a workflow of events in delivering healthcare with at least one resource is provided. The method can comprise the steps of acquiring a generally real-time location data of the patient relative to the at least one resource with progression through the workflow; detecting an association of the patient with the at least one resource dependent on the location data; generating a classification of the patient as receiving emergency care versus receiving urgent care dependent on the association; and generating an output indicative of the classification for communication to a billing system to generate an invoice for delivery of healthcare to the patient.

A computer readable storage medium comprising a plurality of program instructions for execution by at least one processor to perform the steps of: acquiring a generally real-time data of at least one of a location, a movement, and a proximity of the patient relative to the at least one resource with progression through the workflow, and a duration thereof; detecting an association of the patient with the at least one resource dependent on at least one of the location, the movement, the proximity data, and the duration; generating a classification of the patient as receiving emergency care versus receiving urgent care dependent on the association; and generating an output indicative of the classification for communication to a billing system to generate an invoice for delivery of healthcare to the patient.

Various other features, objects, and advantages of the invention will be made apparent to those skilled in the art from the accompanying drawings and detailed description thereof.

### BRIEF DESCRIPTION OF THE DRAWINGS

FIG. 1 is a diagrammatic overview of an embodiment of system to classify a service of healthcare delivered to the patient.

FIG. 2 is a schematic flow diagram illustrating an embodiment of a method to operate the system of FIG. 1 in classifying a service of healthcare delivered to the patient.

FIG. 3 is illustrative of an embodiment of a dashboard operable to report an output of the system and method at any point in time of a patient progressing through the care workflow.

### DETAILED DESCRIPTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

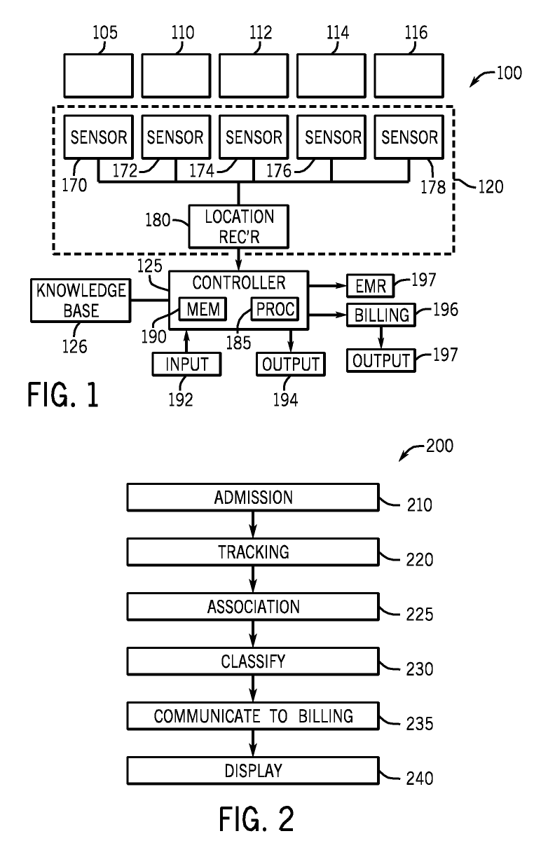

FIG. 1 illustrates a schematic diagram of an embodiment of a system 100 to manage a patient 105 through a workflow in delivering healthcare. An embodiment of the system 100 can automatically differentiate between the classification of urgent care versus emergency care based on procedures performed and association of resources 110, 112, 114, 116 employed in the workflow in delivering healthcare to the patient 105.

An embodiment of workflow as herein used can generally be defined as an embodiment of a sequence of tasks or states or steps or events (e.g., physician examination, laboratory tests, acquire electrocardiogram (ECG) data, etc.) that may or may not employ use or operation or involvement of the series of resources 110, 112, 114, 116 to deliver a defined outcome (e.g., treatment or diagnosis of the patient 105 for chest pain, broken arm, trauma, illness, etc.). The number of resources 110, 112, 114, 116 can vary. An embodiment of the resources 110, 112, 114, 116 can be operable to interact with each other in general real-time, as well as be operable to establish a logical relationship among one another. The resources 110, 112, 114, 116 may be included at the beginning of the workflow or in general real time during or between the events or steps of the workflow. One embodiment of the resources 110, 112, 114, 116 include a care personnel 110 (e.g., physician, nurse, clinician, etc.), an imaging or scanning system 112, and a laboratory device 114, and a defined space 116. Yet, the resources 110, 112, 114, 116 can include test laboratories, etc. or any imaginable element involved in treatment or delivery of healthcare to the patient 105.

An embodiment of the system 100 may further include location system 120 in communication with a controller 125. The location system 120 can include a series of locations devices or sensors 170, 172, 174, 176, 178 operable to track a location of each patient 105 or resource 110, 112, 114, 116, respectively, with respect to a reference or to one another. An embodiment of each sensor 170, 172, 174, 176, 178 is operable to communicate a location of each respective reference. The sensors 170, 172, 174, 176, 178 can be operable to track in coordinates, or by room or floor number, etc. One embodiment of the sensors 170, 172, 174, 176, 178 can be in wireless communication with a transmitter/receiver 180 connected in communication with the controller 125. Yet, the sensors 170, 172, 174, 176, 178 can each include a combination of transmitters or receivers having various modes of detection technology (e.g., radio frequency identification (RFID), optical technology, global positioning system (GPS) in communication with satellite(s), infrared, ultrasonic, shape/scene recognition, video streaming, etc. or other position measuring or locating technology known in the art or combination thereof) and is not limiting on the subject matter described herein.

An embodiment of the controller 125 can be connected in communication to receive updated values or measurements of tracked tracking data acquired by the location system 120 on a continuous or periodic basis with respect to the resources 110, 112, 114, 116 or patient 105. The controller 125 can also be connected to communicate acquired data, algorithms, or output as described herein with a knowledge database 126 for updating and later retrieval.

The controller 125 can include a processor 185 generally configured to execute program instructions stored in the memory 190. Although the memory 190 and processor 185 are shown at the computer 125, it should be understood that there can be more than one processor 185 in communication with more than one memory or storage medium 190 of computer-readable program instructions that are integrated or combined at various locations of the system 100. The controller 125 can also be in communication with an input device 192 (e.g., touch-screen, mouse, keyboard, etc.) and an output device 194 (e.g., audible alarm, LCD monitor, etc.) or combination interface thereof so as to interact with an operator/user.

The system 100 can be connected to communicate with a billing system 196 of an entity/facility or to an electronic medical record (EMR) 197 of the patient 105. The billing system 196 can be generally defined as a computer or server or combination thereof operable to generate invoices for payment due associated with the delivery of healthcare to the patient 105. An embodiment of the billing system 196 can include an output device 198 adaptable to create an output (e.g., soft copy in electronic format, hard-copy on paper, etc.) of the invoice for payment due associated with the delivery of healthcare to the patient 105.

FIG. 2 includes a schematic flow diagram illustrating an embodiment of a method 200 of operation of the system 100 to dynamically manage (e.g., scheduling) the patient(s) 105 through events of the workflow that employs the series of resources 110, 112, 114, 116. It should also be understood that the sequence of the acts or steps of the method 200 as discussed in the foregoing description can vary. Also, it should be understood that the method 200 may not require each act or step in the foregoing description, or may include additional acts or steps not disclosed herein. It should also be understood that one or more of the steps of the method 200 can be represented as computer-readable program instructions for execution by one or more processors.

Assume a healthcare entity or facility that can include resources 110, 112, 114, 116 equipped with sensors (e.g., RFID tag or other location identification hardware) to track movement, location and identification of the resources 110, 112, 114, 116 through the facility.

Step 210 can include admission of the patient 105 to a healthcare facility or entity. The admission step 210 can include assigning the sensor 170 (e.g., RFID tag or other location identification hardware) to the patient 105 such that the sensor information can be associated with tracking movement or progress of the patient 105 through the care pathway or relative to the resources 110, 112, 114, 116 or space or combination thereof.

Step 220 includes tracking movement or location of at least one of the resources 110, 112, 114, 116 relative to the movement or location of the patient 105. An embodiment of step 220 also includes tracking movement or location relative to time. An embodiment of the step 220 can also include tracking a duration of the proximity, location or movement as described above of the resources 110, 112, 114, 116 with respect to one another or the patient 105.

Step 225 includes calculating if there an association occurs between the patient 105 and the at least one resource 110, 112, 114, 116 based at least on the threshold movement or location relative to one another or relative to a room or predetermined area identification, a duration (e.g., threshold minimum or maximum) of the threshold movement or location relative to one another or a defined space (e.g., room), a workflow of events in the delivery of healthcare at the facility, and business rules or combination thereof. An example of the association can be generally defined to be an occurrence of a procedural event based on a proximity, location or movement of resources 110, 112, 114, 116 with respect to one another or the patient 105 or of resources 110, 112, 114, 116.

The step 225 can include applying acquired data for duration of proximity, location, or movement of the resources 110, 112, 114, 116, patient 105, space or combination thereof relative to one another (as described in step 220) to a learning algorithm (e.g., neural network learning algorithm) so as to calculate or adjust variation of the duration associated with occurrence of the association, or vice versa. The calculation or adjustment of variation of the duration can occur for a class of resources (e.g, caregiver, equipment, lab analyses, physician, nurse, etc.) or on an individualized basis for the particular resource 110, 112, 114, 116.

An embodiment of the procedural step or event can generally be defined to be a task of a protocol in the delivery of healthcare to the patient 105, while non-procedural step or event can be associated as a contact of acquaintance that is not related to the delivery of healthcare to the patient 105. For example, the system 100 can calculate or detect that the association has occurred between the patient 105 and one or more resources 110, 112, 114, 116 dependent on the threshold distance therebetween and/or the business rule that associates one or more of the resources 110, 112, 114, 116 to a particular type or classification of a protocol or task of healthcare assigned at admission to deliver to the patient 105.

An embodiment of step 230 can include creating a classification model to identify the type or classification of a protocol or task of healthcare delivered to the patient 105. Step 230 can include acquiring identification of the procedural steps or events or tasks associated with the delivery of healthcare in the care pathway based on reason for admission or symptoms: the sequence associated with the identification of the steps or events or correlation of resources 110, 112, 114, 116 involved or employed for one or more of the steps, events or tasks in the delivery of healthcare; data of a threshold range or proximity, location or movement of the resources 110, 112, 114, 116 relative to the patient 105 for the execution or occurrence of the one or more steps or events of the workflow; or data of a threshold range duration resources 110, 112, 114, 116 in proximity, location or movement relative to the patient 105 for the occurrence or execution of the one or more steps or events of the workflow.

An embodiment of step 230 can include creating a model that classifies or calculates whether the patient 105 is receiving a delivery of urgent care in comparison to or to differentiate from delivery of emergency care. Thereby, based on the detection of associations between the resources 110, 112, 114, 116 or patient 105 with respect to one another, the duration of the association, the steps, events or tasks associated with associations of resources 110, 112, 114, 116 or patient 105 with one another, and comparison of associations to predicted sequence of steps, events or tasks in the delivery of healthcare at the medical facility, the system 100 can classify or calculate whether the patient 105 is receiving urgent care in comparison to emergency care.

An embodiment of the classification model includes a neural network algorithm or similar learning algorithm that in combination with acquired historical data can be adaptive to automatically classify the service to the patient 105 as urgent care versus emergency care. The step 230 can include integrating data acquired with respect to workflow and business rules associated with delivery of urgent care versus emergency care, normalizing the format and content of the acquired data, testing the classification model to classify or calculate the type of delivery of healthcare delivered to the patient 105 based on trial samples of real-time or pre-determined location data and associations detected by the system and the resultant classifications for comparison to appropriate classifications of the patient 105 as receiving urgent care versus emergency care, training or adjustment of the classification model based on appropriate classification of the delivery of urgent care versus emergency care according to the test sample data, and validating the proper function of the classification model.

Step 235 can include communicating the output of the classification model to the billing system 196 or EMR 197. An embodiment of the output of the classification model can be an alphanumeric or other graphic illustration, a code, etc. representative of one of the classification as the delivery of urgent care versus of the classification as the delivery of healthcare to the patient 105. An embodiment of the output of the classification model can be generated as the patient 105 progresses through the care pathway to discharge (and updated accordingly as indicated by the classification model as detected associations may be modified or as new associations are calculated/detected), or based calculation or generation of one output generated at discharge.

Step 240 can include acquiring the output of the type of classification as described in step 235, and calculating a bill or invoice for payment that is associated with the type of classification as described in step 235. An embodiment of the bill or invoice can be a reimbursement code or other known classification code known in the medical service industry. The bill or invoice can also include a first fee for payment from the patient 105 for the delivery of urgent care, to be distinguished or differentiated from a bill or invoice that includes a second fee for payment from the patient 105 for the delivery of emergency care that is different than the first fee.

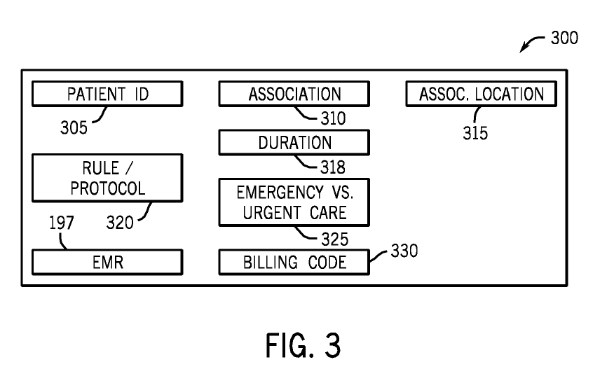

FIG. 3 illustrates an embodiment of a dashboard 300 to illustrate output associated with operation of the system 100 and method 200 described above. The dashboard 300 (e.g., nursing station) generally includes an illustration of an identifier 305 associated with each patient 105 admitted to the facility. The dashboard 300 can further include a graphic representation 310 of the association detected between the patient 105 and one or more resources 110, 112, 114, 116 as described in step 225, a graphic representation 315 of a location of the association, a graphic illustration 318 of a value of duration of the association, a graphic illustration 320 of the business rule or protocol correlated with the association, a graphic illustration 325 of the classification of healthcare delivered to the patient 105 as output from the classification model described in step 230, a graphic representation 330 of the billing code or invoice or interface link (e.g., mouse click activated) thereto, and a graphic representation of a link to communicate the output to the EMR 197 or combination thereof correlated with the graphic illustration 325 of the classification of healthcare delivered to the patient 105. The dashboard 300 can be updated periodically or in general real-time with tracking of the patient 105 through the care pathway.

A technical effect of the above-described system 100 and method 200 can be to organize the tracking data (e.g., location) along with workflow and business rule data in order to compute the presence of the patient 105, physician/staff and equipment 110, 112, 114, 116 within proximity of one another or a recognized room or defined space for a threshold time duration. The system 100 and method 200 can also provide a mechanism to compute the association of resources 110, 112, 114, 116 and duration of association with the patient 105 based on a workflow for a particular procedure, and using the association to classify the service of medical delivery to the patient 105 classified either as urgent care or emergency care for billing purposes, as well as for utilization mining. The system 100 and method 200 can also provide an adaptive framework to classify the type of service of healthcare delivered to the patient 105 so as to automatically feed to billing and miscellaneous hospital information systems. The classification model as described in step 230 includes learning algorithm that in combination with acquired historical data can be adaptive to automatically classify the service to the patient 105 as urgent care versus emergency care, reducing subjectivity and increasing consistency/standardization in the classification process within a hospital or among a system of healthcare providers, as well as increasing independence of classification process from the manual introduction of workflow/protocol, task steps completed and opportunities for errors.

An embodiment of the system 100 and method 200 can be operable to manage various types and number of workflows that may comprise several sub-workflows among several medical facilities. For example, the workflow can include a workflow through a trauma unit, a workflow through an emergency unit or room, and a workflow through an urgent care unit where there is overlap in services or steps/events of the workflow.

This written description uses examples to disclose the subject matter, including the best mode, and also to enable one skilled in the art to make and use the invention. The patentable scope of the subject matter is defined by the following claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A system to manage progression of a patient through a workflow of events occurring in as room or defined space, the workflow of events associated with at least one resource in the delivery of healthcare to the patient, the system in communication with a billing system to invoice the delivery of healthcare to the patient, comprising:
a tracking system operable to acquire a location data of the patient relative to the at least one resource with progression through the workflow; and
a controller in communication with the tracking system, the controller including at least one processor in communication with a memory of a plurality computer readable program instructions operable to instruct the processor to perform the steps of:
detecting an association of the patient with the at least one resource dependent on the location data acquired from the tracking system,
generating a classification of the patient as receiving emergency care versus receiving urgent care dependent on the association, and
generating an output indicative of the classification for communication to a billing system to generate the invoice for delivery of healthcare to the patient.

2. The system of claim 1, wherein the at least one resource includes one of the following: a medical diagnostic system, a care personnel, and a staff.

3. The system of claim 1, wherein the association depends on one or more of the following: the location of the patient relative to the at least one resource, the location of the patient and the at least one resource relative to the defined space, a duration of patient within proximity of at least one resource, and a duration of the patient within proximity relative to the defined space.

4. The system of claim 1, wherein the location system includes at least one of the following detection technologies: radio frequency identification (RFID), optical, global positioning system (GPS), infrared, shape recognition and ultrasonic.

5. The system of claim 1, wherein the classification model includes a neural network algorithm that in combination with acquired historical data can be adaptive to automatically classify the delivery of emergency care versus the delivery of urgent care to the patient.

6. The system of claim 5, further comprising:
a dashboard to illustrate the output of the classification model, the dashboard including one or more of the following: a graphic representation of the association detected between the patient and one or more resources, a graphic representation of a location of the association, a graphic illustration of a value of duration of the association, a graphic illustration of the business rule or protocol correlated with the association, a graphic illustration of the classification of delivery of emergency care versus the delivery of urgent care to the patient, and a graphic representation of a billing code associated with the delivery of emergency care versus the delivery of urgent care.

7. The system of claim 1, wherein the classification model includes a neural network learning algorithm.

8. A method to manage progression of a patient through a workflow of events in delivering healthcare with at least one resource, comprising the steps of:
acquiring a generally real-time location data of the patient relative to the at least one resource with progression through the workflow;
detecting an association of the patient with the at least one resource dependent on the location data;
generating a classification of the patient as receiving emergency care versus receiving urgent care dependent on the association; and
generating an output indicative of the classification for communication to a billing system to generate an invoice for delivery of healthcare to the patient.

9. The method of claim 8, wherein the at least one resource includes one of the following: a medical diagnostic system, a physician, and a staff.

10. The method of claim 8, wherein the location data includes one or more of the following: the location of the patient relative to the at least one resource, the location of the patient and the at least one resource relative to the defined space, and a duration of the association of the patient with the at least one resource, and a duration of the association of the association of the patient in the defined space.

11. The method of claim 8, wherein the location system includes at least one of the following detection technologies: radio frequency identification (RFID), optical, global positioning system (GPS), infrared, shape recognition and ultrasonic.

12. The method of claim 8, wherein the classification model includes a neural network algorithm that in combination with acquired historical data can be adaptive to automatically classify the delivery of emergency care versus the delivery of urgent care to the patient.

13. The method of claim 8, further comprising the step of generating a dashboard to illustrate the output of the classification model, the dashboard including one or more of the following: a graphic representation of the association detected between the patient and one or more resources, a graphic representation of a location of the association, a graphic illustration of a value of duration of the association, a graphic illustration of the business rule or protocol correlated with the association, a graphic illustration of the classification of delivery of emergency care versus the delivery of urgent care to the patient, and a graphic representation of a billing code associated with the delivery of emergency care versus the delivery of urgent care.

14. The method of claim 8, wherein the classification model includes a neural network learning algorithm.

15. A computer readable storage medium comprising a plurality of program instructions for execution by at least one processor to perform the steps of:
acquiring a generally real-time data of at least one of a location, a movement, and a proximity of the patient relative to the at least one resource with progression through the workflow, and a duration thereof;
detecting an association of the patient with the at least one resource dependent on at least one of the location, the movement, the proximity data, and the duration;
generating a classification of the patient as receiving emergency care versus receiving urgent care dependent on the association; and
generating an output indicative of the classification for communication to a billing system to generate an invoice for delivery of healthcare to the patient.

16. The computer readable storage medium of claim 15, wherein the location data includes one or more of the following: the location of the patient relative to the at least one resource, the location of the patient and the at least one resource relative to the defined space, and a duration of the association of the patient with the at least one resource, and a duration of the association of the association of the patient in the defined space.

17. The computer readable storage medium of claim 15, wherein the location system includes at least one of the following detection technologies: radio frequency identification (RFID), optical, global positioning system (GPS), infrared, shape recognition and ultrasonic.

18. The computer readable storage medium of claim 15, wherein the classification model includes a neural network algorithm that in combination with acquired historical data can be adaptive to automatically classify the delivery of emergency care versus the delivery of urgent care to the patient.

19. The computer readable storage medium of claim 15, further comprising program instructions to instruct the at least one processor to perform the step of:
generating a dashboard to illustrate the output of the classification model, the dashboard including one or more of the following: a graphic representation of the association detected between the patient and one or more resources, a graphic representation of a location of the association, a graphic illustration of a value of duration of the association, a graphic illustration of the business rule or protocol correlated with the association, a graphic illustration of the classification of delivery of emergency care versus the delivery of urgent care to the patient, and a graphic representation of a billing code associated with the delivery of emergency care versus the delivery of urgent care.

20. The computer readable storage medium of claim 15, further including a instruction to instruct the processor to communicate an indication of the classification to an electronic medical record of the patient.
